(19) United States
(12) Patent Application Publication
(10) Pub. No.: US 2002/0034126 A1
(43) Pub. Date: Mar. 21, 2002

(54) Device for electrically connecting an electrical power source and an electronic circuit of a timpiece

(76) Inventors: Ronald Flury, Lengnau (CH); Markus Kaiser, Solothurn (CH)

Correspondence Address: Richard K. Robinson Attorney at low, North Dallas Bank Tower, Suite 1202, 12900 Preston Road, LB-41, Dallas, TX, 75230, US

(21) Appl. No.: 09/953,711

(22) Filed: Sep. 17, 2001

(30) Foreign Application Priority Data
Sep. 19, 2000 (CH) 1822/00

(51) Int. Cl. G04B 1/00; G04C 3/00

(52) U.S. Cl. 368/204

(57) ABSTRACT

There is disclosed an electronic device assuring an electrical connection between a source of electrical power (4), such as a battery, and an electronic circuit (3) of a timepiece. This device includes at least one electrical connector tongue (5) effecting an electrical connection between said source of electrical power (4) and said electronic circuit (3), mounted on a support (2) of the timepiece and having a pair of apertures (55, 56) cooperating with a pair of securing pins (25, 26) fixed to the support (2). The electrical connector tongue (5) further includes at least a first pair of fingers (55a, 55b, 56a, 56b) framing and defining a first of said apertures (55, 56), these fingers being adapted to deform at least resiliently in order to modify the diameter of said first aperture and to allow said electrical connector tongue to be engaged and held on at least a first of said securing pins (25, 26).

The present invention concerns an electronic device for a timepiece of the electronic or electromechanical type including a source of electrical power, an electronic circuit and at least one electrical connector tongue effecting an electrical connection between said source of electrical power and said electronic circuit. The present invention also concerns an electrical connector tongue adapted to be fitted on a plate of an electronic or electromechanical timepiece in order to effect an electrical connection between a source of electrical power and an electronic circuit of the timepiece.

Electromechanical or electronic timepieces usually include a resonator, for example a quartz resonator, the vibrations of which are maintained by an electronic control circuit powered by a source of electrical power such as a button-type battery. Electromechanical timepieces further include a horometric movement controlled by the electronic control circuit associated with the resonator. The battery thus powers the electronic circuit which maintains the resonator's vibrations and, if necessary, provides the drive pulses to a motor of the horometric movement. In order to connect this battery to the electronic control circuit, electrical connector means which form a supply path are provided.

These electrical connector means forming the supply path generally include two, respectively frontal and lateral, electrical connector tongues, the first being arranged to come into contact with a first terminal (for example the negative terminal) of the battery, while the second is held applied against the second terminal (for example the positive terminal) of the battery.

Typically, these electrical connector tongues are secured to a plate by conventional fixing means, for example by rivets or by means of screws. This has the drawback of making the assembly relatively complex to assemble, in particular during automated assembling. This type of fixing means also makes any subsequent replacement of such a tongue in the timepiece difficult.

Moreover, the use of fixing means formed of screws, particularly on a plate made of plastic material, may cause problems of wear in addition to the drawbacks already mentioned.

The object of the present invention is thus to overcome the aforementioned drawbacks by proposing a device including electrical connector means the structure and securing of which are simplified.

In order to attain this object, it will be noted that Japanese Patent No. 267 1838 has already proposed electrical connector means for an electronic timepiece which do not require complex securing means. The electrical connector means disclosed in this patent include an electrical connector tongue guided by means of a pair of pins cooperating with a pair of apertures arranged in the tongue. This electrical connector tongue is however only held in place via the combined action of the battery and the electronic circuit. Without this action, the tongue is capable of becoming detached from the pins, which can constitute a problem in particular when this tongue is assembled or when the battery is changed.

Another object of the present invention is thus to propose a device including electrical connector means which do not require complex securing means, such as screws or rivets, and which is nonetheless secured in the timepiece adequately and securely.

Another object of the present invention is to facilitate the mounting, and, if necessary, the subsequent replacement of the electrical connector means in the timepiece.

In order to attain these objects, the Applicant proposed, within the scope of European Patent Application No. 00203072.4 filed Sep. 6, 2000 (such Application claiming priority of European Patent Application No. 99117614.0 of Sep. 7, 1999), electrical connector means including an electrical connector tongue intended to be mounted on a plate of an electronic or electromechanical timepiece in order to assure an electric connection between the source of electrical power and the electronic circuit of the timepiece, this electrical connector tongue having a pair of apertures intended to collaborate with a pair of securing pins fixed to the plate of the timepiece. According to this European Patent Application, the electrical connector tongue also has, arranged between the pair of apertures, a section adapted to deform in a resilient manner in order to modify the spacing between the apertures and to allow the electrical connector tongue to be engaged and held on the securing pins.

The Applicant has nonetheless been able to observe that this first solution requires a recess for accommodating the section which is able to deform in a resilient manner. In certain cases, this recess may not be possible, so that a less cumbersome solution which nonetheless answers the same objects has been sought.

The present invention thus concerns an electronic device for a timepiece of the electronic or electromechanical type the features of which are listed in claim 1.

Advantageous embodiments of this device form the subject of the dependent claims.

As for the solution provided in the aforementioned European Patent Application, also in the name of the Applicant, the solution provided by the present invention also allows the manufacture and mounting of the electrical connector means in a timepiece to be facilitated while assuring that the said means are properly secured. The present invention however provides a solution which is also very compact.

The present invention also concerns a timepiece of the electronic or electromechanical type including such a device, and an electrical connector tongue intended to be mounted in an electronic or electromechanical timepiece the features of which are listed in claim 8.

Other features and advantages of the present invention will appear upon reading the following description, made with reference to the annexed drawings, given solely by way of example, and in which:

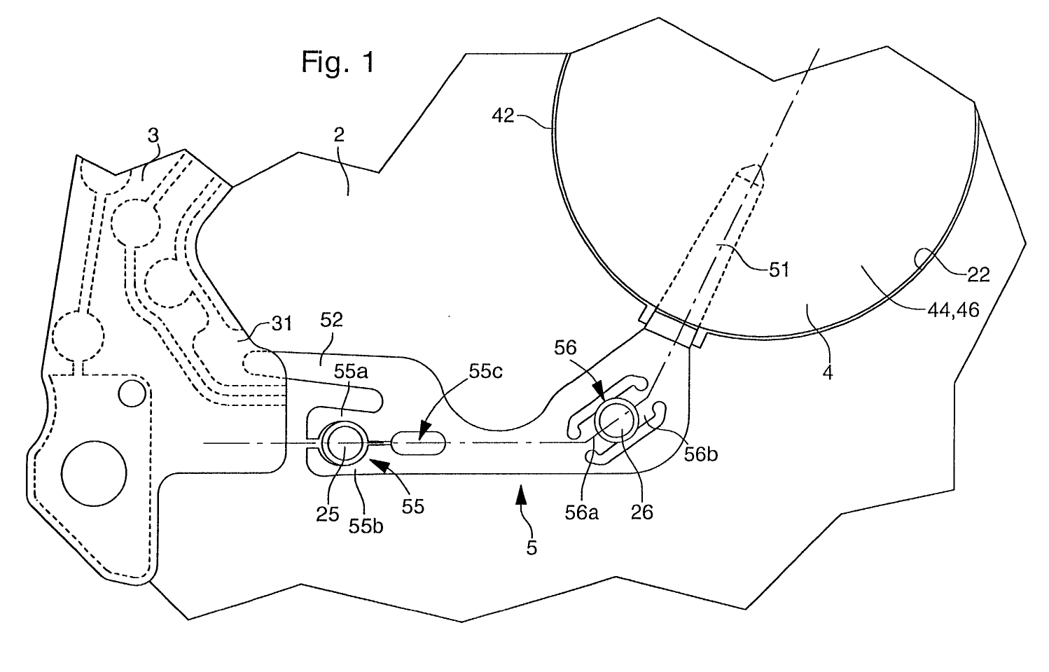

FIG. 1 is a plan view of a portion of a timepiece including a plate, an electronic circuit, a power source and electrical connector means including an electrical connector tongue according to the present invention; and

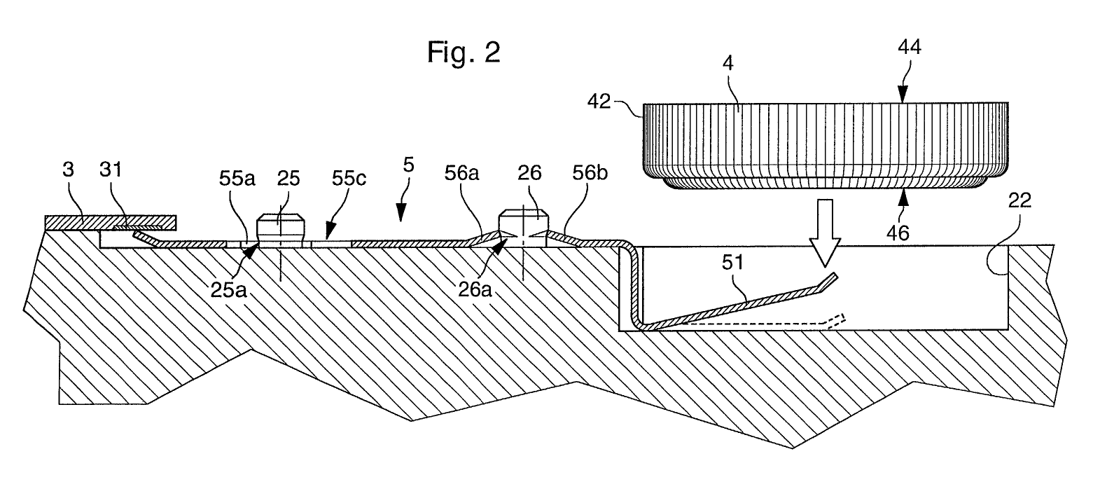

FIG. 2 is a cross-section of the portion of the timepiece of FIG. 1 illustrating the electrical connector means according to the present invention.

The annexed Figures show a timepiece including a plate 2 forming a support, advantageously made of a synthetic material such as an injection moulded plastic. The timepiece also includes an electronic circuit 3 with which is associated a resonator, for example a quartz resonator (not shown).

In the case of an electromechanical timepiece, this latter also includes a horometric movement provided with a motor, such as a stepping motor, controlled by drive pulses emanating from electronic circuit 3. Since these elements do not form the subject matter of the present invention, they have not been shown in the Figures.

In order to power electronic circuit 3 and, if necessary, the motor, the timepiece is also provided with a power source, formed in this example, by a button-type battery 4. This battery 4 supplies the electrical power necessary for electronic circuit 3, which maintains the oscillation of the quartz oscillator, to operate and, if required, powers the motor of the horometric movement.

This type of battery, such as button-type battery 4, is of a widely marketed type and is used very commonly in electronic or electromechanical timepieces. Battery 4 is of essentially cylindrical shape and has an edge or periphery 42 which has the shape of a portion of a cylinder, delimited on either side by two substantially plane regions of larger surface area, respectively 44 and 46. One of these regions, in this example region 46 oriented towards plate 2, and the cylindrical periphery 42 respectively form the negative (−) and positive (+) terminals of battery 4. Battery 4 is disposed in a cavity 22 arranged in plate 2, the negative terminal of battery 4, namely region 46, being oriented towards the bottom of this cavity 22.

In order to assure the powering of electronic circuit 3, the timepiece includes electrical connector means forming a supply path. These electrical connector means include on the one hand a frontal electrical connector tongue 5 supported by plate 2 and forming the negative part of the supply path. A first end part 51 of this electrical connector tongue 5 assures contact with the negative terminal 46 of battery 4. A second end part 52 of electrical connector tongue 5 assures an electric contact with a supply path 31 of electronic circuit 3.

The electrical connector means include on the other hand a lateral electrical connector tongue, which is not shown, forming the positive part of the supply path. This part may be made conventionally and is within the grasp of those skilled in the art. It will however be mentioned that this lateral electrical connector tongue may also be made according to the teaching of the present invention.

The electrical connector tongues may advantageously be made in the form of stamped metal plates, for example from a spring steel plate.

The end parts 51 and 52 of electrical connector tongue 5 are adapted to deform in a resilient manner under the effect of electronic circuit 3 and battery 4 so that these end parts 51 and 52 are held in contact against negative terminal 46 of battery 4 and supply path 31 of electronic circuit 3 after assembly. FIG. 2, which shows a cross-section of a portion of the timepiece, thus shows by way of illustration, the position of end part 51 of frontal electrical connector tongue 5 in its rest position when battery 4 is not mounted in the timepiece.

According to the present invention, frontal electrical connector tongue 5 further includes a pair of apertures 55 and 56 forming part of the means for securing tongue 5 to plate 2. In this example, each aperture 55, 56 is defined by a pair of fingers of the electrical connector tongue respectively designated 55a, 55b and 56a , 56b, these fingers being adapted to deform at least resiliently in order to modify the diameter of the corresponding aperture. It will be understood from FIG. 2 that each pair of fingers 55a, 55b and 56a, 56b, respectively “frame” and define apertures 55 and 56.

Within the scope of the present invention “finger” will be understood to mean an extension of the tongue having a free end and an end secured to the body of tongue 5.

The securing means also include a pair of securing pins 25 and 26 fixed to plate 2 and used to hold frontal electrical connector tongue 5 in place in the timepiece.

More specifically, aperture 55 is defined by the spacing existing between fingers 55a and 55b of tongue 5, these fingers being adapted to deform at least resiliently in a plane substantially parallel to the plane of tongue 5 and plate 2. Similarly, aperture 56 is defined by the spacing existing between fingers 56a and 56b of tongue 5, these fingers being adapted to deform at least resiliently in a plane substantially perpendicular to the plane of tongue 5 and plate 2.

It will be noted that fingers 55a and 55b framing and defining the first aperture 55 are disposed substantially parallel to each other. At this point, the tongue is in a way slit over a certain length so as to allow deformation in the plane of the tongue (i.e. in a plane substantially perpendicular to the direction of extension of securing pin 25). In order to facilitate the spacing of fingers 55a and 55b a recess 55c may be made between the fingers as illustrated in FIG. 2.

Likewise, it will be noted that fingers 56a and 56b framing and defining second aperture 56 are disposed so as to face each other and are arranged so that a deformation in a plane substantially perpendicular to the tongue (i.e. in a substantially parallel plane to the direction of extension of securing pin 26) is made possible.

Within the scope of the present invention, it will be understood that electrical connector tongue 5 may perfectly well be held by two pairs of fingers both adapted to deform in a plane perpendicular to the direction of extension of pins 25 and 26 or, alternatively, by two pairs of fingers both adapted to deform in a plane parallel to the direction of extension of pins 25 and 26. The example illustrated in the Figures shows a combination of these two “types” of fingers and is in no way limiting for the application of the present invention.

It will further be understood that fingers 55a and 55b holding tongue 5 on pin 25 may perfectly well be replaced by fingers of the same type as fingers 56a, 56b, namely fingers capable of deforming in a plane substantially parallel to the direction of extension of pin 25. This is also true for the mode for securing tongue 5 to pin 26.

Prior to mounting, it will be understood that the spacing of fingers 55a, 55b and 56a, 56b is such that the diameter of apertures 55 and 56 thereby defined is less than the diameter of securing pins 25, 26. Thus, when the electrical connector tongue is mounted on the plate 2 of the timepiece, the spacing of fingers 55a, 55b on the one hand, and of fingers 56a, 56b, on the other hand, is modified by the presence of the corresponding securing pin 25 and 26, i.e. the fingers undergo a deformation (at least resiliently) allowing electrical connector tongue 5 to be engaged then held on securing pins 25 and 26.

According to a first embodiment, electrical connector tongue 5 can be held in place on securing pins 25 and 26 via a pinching effect, i.e. via the action of return forces tending to return the fingers to their rest position. In particular, according to this first embodiment, the fingers made of metal material can perfectly well penetrate slightly the softer plastic material, of which support (or plate) 2 and pins 25, 26 are preferably formed, in order to hold tongue 5 securely in place.

According to another embodiment, as illustrated in the Figures, securing pins 25 and 26 can have a substantially cylindrical shape and include, in their lower part, respectively radial indentations 25a and 26a in which fingers 55a, 55b and 56a, 56b respectively engage. The resilience of the fingers thus allows the engagement of electrical connector tongue 5 on the upper part of securing pins 25, 26, fingers 55a, 55b and 56a, 56b then engaging in respective indentations 25a and 26a of securing pins 25 and 26. This solution advantageously prevents the electrical connector tongue from accidentally being released.

In the example illustrated in FIG. 2, it will be understood that the fingers can simply be arranged so as to allow tongue 5 to engage on securing pins 25, 26, the tongue essentially being held by radial indentations 25a, 26a arranged in the securing pins. In this example, fingers 55a, 55b and 56a, 56b thus contribute to holding the tongue by engaging in radial indentations 25a, 26a.

Multiple modifications and/or improvements may be made to the electrical connector tongue according to the present invention without departing from the scope and spirit thereof. It will be understood, in particular, that the present invention is not limited only to the embodiment of a frontal electrical connector tongue as described hereinbefore, but may also easily be applied to the embodiment of a lateral electrical connector tongue which comes into contact, directly or indirectly, with the positive terminal of the battery.

What is claimed is:

1. An electronic device for a timepiece of the electronic or electromechanical type including source of electrical power, an electronic circuit and at least one electrical connector tongue effecting an electrical connection between said source of electrical power and said electronic circuit, this electrical connector tongue having a pair of apertures cooperating with a pair of securing pins fixed to a support of said device,
wherein said electrical connector tongue further includes at least a first pair of fingers framing and defining a first of said apertures, these fingers being adapted to deform at least resiliently in order to modify the diameter of said first aperture and to allow said electrical connector tongue to be engaged and held on at least a first of said securing pins.

2. A device according to claim 1, wherein said electrical connector tongue further includes a second pair of fingers framing and defining the second of said apertures, these fingers being adapted to deform at least resiliently in order to modify the diameter of said second aperture and to allow said electrical connector tongue to be engaged and held on the second of said securing pins.

3. A device according to claim 1, wherein at least one of the pairs of fingers is adapted to deform in a plane substantially perpendicular to a direction in which the corresponding securing pin extends.

4. A device according to claim 1, wherein at least one of the pairs of fingers is adapted to deform in a plane substantially parallel to a direction in which the corresponding securing pin extends

5. A device according to claim 1, wherein at least one of said securing pins includes, in its lower part, a radial indentation in which said pair of corresponding fingers engages, the upper part of said securing pin preventing the electrical connector tongue from being accidentally released.

6. A device according to claim 1, wherein said support is made of plastic material and said electrical connector tongue is made from spring steel.

7. A timepiece of the electronic or electromechanical type including an electronic device according to claim 1.

8. An electrical connector tongue adapted to be fitted on a plate of an electronic or electromechanical timepiece in order to effect an electrical connection between a source of electric power and an electronic circuit of said timepiece, said electrical connector tongue having a pair of apertures adapted to cooperate with a pair of securing pins fixed to a support of the timepiece,
this electrical connector tongue being wherein it further includes at least a first pair of fingers defining a first of said apertures and adapted to deform at least resiliently in order to modify the diameter of said first aperture and to allow said electrical connector tongue to be engaged and held on at least a first of said securing pins.

9. A tongue according to claim 8, wherein it further includes a second pair of fingers defining the second of said apertures adapted to deform at least resiliently in order to modify the diameter of said second aperture and to allow said electrical connector tongue to be engaged and held on the second of said securing pins.

10. A tongue according to claim 8, wherein at least one of the pairs of fingers is adapted to deform at least resiliently in a plane substantially perpendicular to a direction in which the corresponding securing pin extends.

11. A tongue according to claim 8, wherein at least one of the pairs of fingers is adapted to deform at least resiliently in a plane substantially parallel to a direction in which the corresponding securing pin extends.

12. A tongue according to claim 8, wherein the latter is made from spring steel.
